(19) United States
(12) Patent Application Publication
(10) Pub. No.: US 2002/0107943 A1
(43) Pub. Date: Aug. 8, 2002

(54) Reset control in modular network computers

(76) Inventors: Chester A. Heath, Boca Raton, FL (US); Kendall A. Honeycutt, Boca Raton, FL (US); Ray Garcia, Boca Raton, FL (US)

Correspondence Address: KAPLAN & GILMAN , L.L.P., 900NROUTE 9 NORTH, WOODBRIDGE, NJ, 07095, US

(21) Appl. No.: 09/775,766

(22) Filed: Feb. 3, 2001

Related U.S. Application Data
(60) Provisional application No. 60/248,497, filed on Nov. 10, 2000.

(51) Int. Cl. G06F 15/16; G06F 17/00; G06F 15/177

(52) U.S. Cl. 709/220

(57) ABSTRACT

The present invention describes a system for enabling a host computer to reset individual client computers. The invention allows the host to apply the reset to any or all clients, and to inhibit additional resets during a host power-on event. The invention additionally allows individual client modules to reset other client modules, given that the issuer is authorized and equipped to do so.

### FIELD OF THE INVENTION

This invention relates generally to networked computer systems. More particularly, this invention relates to control signals communicated between a host computer and client computers on a networked computer system.

### BACKGROUND OF THE INVENTION

Many computer networks use what is known as client/server system in which a network host computer provides a number of centralized hardware and software resources for a number of client computers in the network. Traditional network topologies organize the network server and clients as separate and individually controlled units. Each client is generally a stand-alone PC, and as such can operate independently of the network host. This includes such control functions as power on/off and reset of adapter or peripheral cards contained in the PC. Likewise the server is generally a fully independent computer, and is capable of independent processing, power cycling and reset or re-initialization.

One disadvantage with such networked systems is that individual client computers in the network cannot be reset by an explicit command from the host. Therefore in the event that a particular application running on a client machine and in communication with other network participants disrupts the systems, the host has no means by which the disrupting application can be halted. In severe situations, it may be required to sever the connection and cycle the power to all machines involved.

More recently, modular networks have become available, in which a small local area network is comprised of a host computer with a plurality of modular single board computers (MSBC) electrically connected to the host. The MSBC's are generally implemented as components connected on a printed circuit board, in the format of a replaceable feature card for a host system, and plugged into one of a set of bussed connectors forming the backplane of the host computer. The MSBC may be rendered, for example, on a 12″×5″ card, with the bus connector for the host backplane at one end, and I/O ports installed in a bracket at the far end. The cards comprise the client computer, which then communicates with a remote client terminal by cable connection to the I/O ports of the MSBC. The Host most often functions as a server or peer client.

In analogy to traditional networks, the individual host computers of a modular network may also be interconnected into a network cluster.

Modular networks do not suffer from the same disadvantage described above for traditional networks, in which the host is unable to halt a client application. For modular networks, applications running on client PC cards can indeed be halted by resetting or reinitializing (Cntl+Alt+Del) the host computer. However, because of the configuration of the modular network, all client MSBC's will be reset or powered down as a result of a host reset, as the clients PC cards are plugged directly into the host bus. This obviates many of the advantages of having independent computers attached via the network. In fact, software applications, operating systems, network management tools and user training have become accustomed to this characteristic, and it has become a de facto standard and required for compatibility.

While a host system power failure may be made unlikely by application of redundant or uninterruptible power supplies, reset conditions may occur spontaneously. For example, as a result of processing activity among the plurality of client computers, conflicting commands may disrupt the timing or logic flow of the host computer, resulting in a “hung” state. Only a reset affecting all on-board cards may clear the hung condition of the host.

A number of patents recognize the need for partial control of otherwise independent client computers. For example, in Truong et al., U.S. Pat. No. 6,160,873, issued Dec. 12, 2000, a system and method are described for allowing remote initialization, operation, and monitoring of a general-purpose computer and its power supply. This functionality is achieved through bi-directional control of the computer by a remote user via telephone. The telephone signals are received and converted to keyboard control signals, allowing for operations executable by the computer to be remotely generated. This approach is impractical, however, for modular networks where the host and the clients are essentially collocated.

Another approach can be found in Shah, et al., U.S. Pat. No. 6,141,711, issued Oct. 31, 2000. This invention describes a secondary bus operating in conjunction with the primary bus, wherein the secondary bus handles the installation or removal of various hardware or peripheral devices. The cost and complexity of a secondary bus however, is prohibitive when applied to a large numbers of networked computers.

Therefore, it remains a heretofore unresolved problem with modular networks, that individual client computers cannot be reset by the host, and that if a reset is issued by the host, it is applied globally to all client computers.

### BRIEF DESCRIPTION OF THE DRAWINGS

FIG. 1 is a generalized drawing of a modular network; and

FIG. 2 is a simplified schematic of an electronic logic circuit, according to this invention.

### DETAILED DESCRIPTION OF THE PREFERRED EMBODIMENT

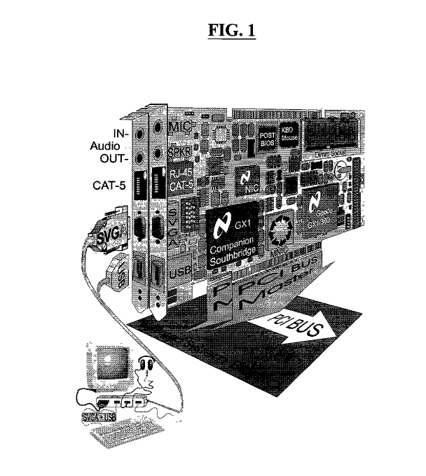

The present invention describes a system which enables a host to specifically address one or more of the clients of a modular network, when issuing a reset command. FIG. 1 shows an illustration of an exemplary modular network, in which a plurality of modular single-board computers (MSBC's) is connected to an ultra high-speed bus belonging to a host computer. The host contains shared resources such as memory, storage, peripherals and software, which is available to the MSBC's to improve their performance capabilities. The bus serves as the transmission medium between the client computers, and as a conventional parallel bus between the client computers and the host resources.

MSBC cards are initialized per standard automatic configurations protocols, such as Plug and Play, and include unique Media Access Control addresses for network configuration. MSBC cards also contain standard power-on self test initialization routines in non-volatile memory for the initialization of the computer itself. MSBC cards also include circuitry to detect power on, and produce a general reset to all components on the card to simulate initialization procedures, as any independent PC would have.

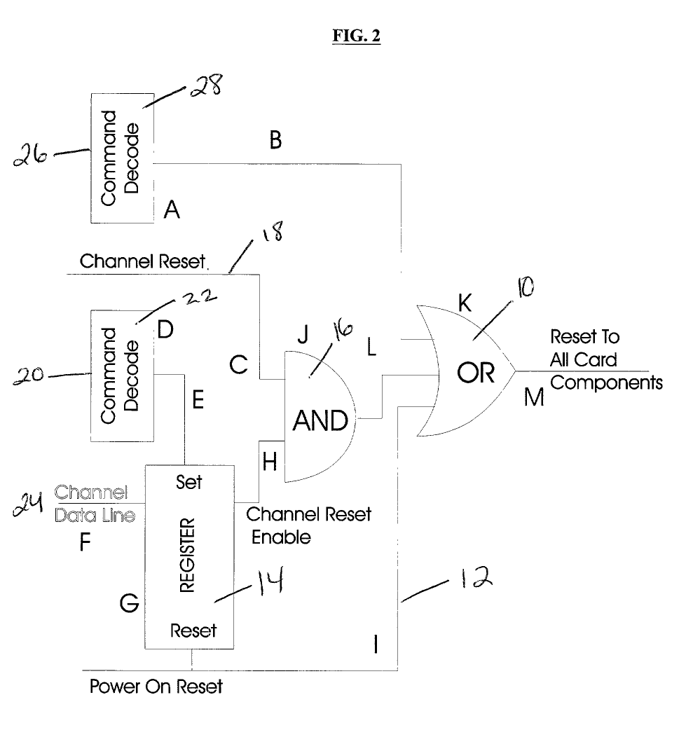

FIG. 2 is a simplified schematic of the logic circuitry embodying this invention. This circuitry is installed on each individual MSBC in the modular network. More specifically, elements 10, 12, 14, 16, 22, and 28 are on board each of the client MSBC's; the input lines 12, 18, 20, 24 and 26 are available to every MSBC.

An OR gate 10 couples three inputs, any or all of which can initiate a reset to all components of an individual MSBC card. The first input line 12 is the power-on reset line of the host computer. This line is activated in the event that the host experiences a disruption causing its power to be cycled or its components to be reset. Line 12 is delivered to each of the MSBC's through an contiguous line 12 inputting the signal to the OR gate 10, causing all components on all cards to be reset.

Line 12 also provides a trigger for enable/disable register 14, which serves to inhibit further resets from being issued to the MSBC for a specified period of time. When line 12 is energized, register 14 outputs a low signal to AND gate 16, causing the output of the AND gate to go low. This output is applied to the second of the three input ports of the OR gate 10, so that no reset is issued as long as enable/disable register is low. The other input to the AND gate is the channel reset line 18. Therefore, signals from this line are ignored until the enable/disable register is cleared. Therefore, AND gate 16 serves to inhibit the MSBC from responding to a reset command during power cycling of the host.

AND gate 16 can be enabled by line 20, which can deliver the clear signal to register 14. When line 20 is activated, command decode electronics 22 interprets the command and determines whether it is directed at this particular MSBC. If the command is indeed addressed appropriately, register 14 is set to a state defined by channel data line 24. The setting of the enable/disable register 14 allows the AND gate to pass a channel reset command from line 18. If the reset signal is presented when register 14 is enabled, the command is passed to OR gate 10 and applied to the module. The purpose of the AND gate, operating in conjunction with the enable/disable register, is to avoid multiple or conflicting reset commands from being applied to the MSBC.

The last of the inputs is line 24, which is an explicit command line from the host to the module, to apply a reset to the components of the MSBC. This signal passes through a similar set of command decode electronics 26. This circuitry resolves a limitation of traditional networks as outlined above, in which the host is unable to directly reset a client computer.

AND gate 16 also allows individual MSBC's to reset one or more other MSBC's. This is accomplished through command decode electronics 22. A client MSBC can issue instructions for specified modules to be reset, by sending the appropriate command to the bus along with the addresses of the targeted MSBC's. Command decode electronics 22 aboard each MSBC interprets the addresses and applies the appropriate signal to enable/disable register 14. Each module properly addressed by line 20 via the individual command electronics 22 will be reset via the circuitry embodying this invention in FIG. 2. In order to control the issuance of such commands, a specific computer can be configured by hardware or software to have the requisite authority. Techniques to endow such authority, on a limited number of trusted systems, are well known in the art and are not detailed here.

It should be evident to one skilled in the art, by reference to the foregoing embodiment, that many design alternatives exist without departing from the spirit and scope of this invention. For example in the embodiment described above, the modular network system is defined with one modular PC per card, which then plugs into the socket of a host system. This may be advantageous when MSBC cards are added to systems in an existing information infrastructure, or in standard systems for general deployment. As technology improves, multiple MSBC functions may exist on a single card, such that the cards themselves comprise miniature networks. This invention may be scaled commensurately and applied to each subsystem on the card. Furthermore, these multi-PC cards be architected in a hierarchical fashion, to unite large numbers of processors in very large networks and coordinated systems. Again, this invention is applicable to such complex, hierarchical structures by application of the invention to individual computer modules or to arbitrarily defined groups of computer modules.

In another embodiment, this invention can be applied to systems that do not form networks, yet implement multiple independent processing systems on a common bus, network, file interface, or other means of file connectivity.

It should be further understood by those skilled in the art, that various electronic functions performed by hardware components in the embodiments described, may also be performed by software, and vice-versa.

In an additional embodiment of the invention, the MSBC's can be used to reset the Host computer. The MSBC can be set to detect any condition that requires reset of the host, such as a faulty power supply. As the MSBC is immune by design to the power on reset, by the circuitry disclosed, only the host is reset. This function is desirable where a program running on the MSBC processor, potentially communicating with an external systems, can be used to revive a hung host machine. The host may be a traditional server or client system and the card may be installed solely for the purposes of effecting an external reset of the host. Moreover, the client may reconfigure to appear as the host to the other clients.

While the invention has been particularly described and illustrated with reference to a preferred embodiment, it will be understood by those skilled in the art that changes in the description and illustrations may be made with respect to form and detail without departing from the spirit and scope of the invention. Accordingly, the present invention is to be considered as encompassing all modifications and variations coming within the scope defined by the following claims.

We claim:

1. Logic circuitry in a computer, the logic circuitry comprising means for distinguishing between multiple reset commands issued by a primary computer and by said computer, and means for inhibiting all but one of said reset commands from resetting said computer at any one time.

2. The logic circuitry of claim 1, further comprising:
a power on/off signal line originating from said primary computer;
one or more decode modules which interpret commands received from said primary computer;
one or more programmable registers which assume a prescribed state in response to said interpreted commands and said power on/off signal line;
one or more AND gates which output a signal indicative of the status of said decode module and said programmable register;
one or more OR gates which applies a reset signal to the components of the computer, in response to the status of said AND gate, said programmable and said power on/off line.

3. Logic circuitry of claim 2, further comprising an explicit reset line controlled by said primary computer and input to said OR gate.

4. A modular computer network system comprising:
a primary computer; and
one or more modular computer units, equipped with logic circuitry enabling said primary computer to issue reset commands to a subset of the equipped modular computer units.

5. The modular computer network of claim 4, further comprising:
a power on/off signal line originating from said primary computer;
one or more decode modules which interpret commands received from said primary computer;
one or more programmable registers which assume a prescribed state in response to said interpreted commands and said power on/off signal line;
one or more AND gates which output a signal indicative of the status of said decode module and said programmable register;
one or more OR gates which applies a reset signal to the components of the target computer, in response to the status of said AND gate, said programmable and said power on/off line.

6. The modular computer network of claim 6, further comprising an explicit reset line controlled by said primary computer and input to said OR gate.

7. The modular computer network of claim 6, wherein the modular computer units are connected through a common shared memory.

8. The modular computer network of claim 6, wherein the modular computer units are connected by a parallel bus.

9. The modular computer network of claim 6, wherein the modular computer units are synchronized by the primary computer, by the issuance of explicit reset commands.

10. The modular computer network of claim 6, wherein the modular computer units are synchronized by the issuance of a reset command.

11. The modular computer network of claim 6, wherein the modular computer units comprise more than one processing device per module.

12. The modular computer network of claim 6, wherein the modular computer units are arranged in a hierarchy, with one modular computer unit controlling groups of subordinate computer units.

13. A computer system comprising a host computer and plural client computers, at least one of said client computers including circuitry for monitoring said host computer, and for detecting a fault state, and transmission circuitry for transmitting a reset signal to said host computer from said at least one client computer in response to detecting said fault.

14. The computer system of claim 13 wherein said circuitry for detecting includes circuitry for monitoring a clock signal being utilized by said host computer.

15. The computer system of claim 13 wherein said circuitry for detecting includes circuitry for monitoring a clock signal being utilized by said host computer.

16. The computer system of claim 13 wherein said circuitry for detecting includes circuitry for receiving a signal from a source other than said host, over a network, in order to indicate a fault with the host.

17. The computer system of claim 13 wherein the circuitry for detecting includes circuitry for executing a diagnostic software program.

18. The computer system of claim 13 further comprising circuitry for configuring said client computer as a host computer in response to detecting a fault with the host computer.
